(19) United States
(12) Patent Application Publication
(10) Pub. No.: US 2012/0023690 A1
(43) Pub. Date: Feb. 2, 2012

(54) METHOD FOR CONTINUOUSLY PRODUCING SPONGE BODIES MADE OF REGENERATED CELLULOSE AND A SPONGE BODY

(75) Inventors: Marc Hunger, Viemheim (DE); Jörg Hausdorf, Furth (DE); Heike Nowottnick, Augsburg (DE); Niklas Kvarnlöf, Karlstad (SE); Peter Lehnhardt, Norrkoping (SE)

(73) Assignee: Carl Freudenberg KG, Weinheim (DE)

(21) Appl. No.: 13/256,975

(22) PCT Filed: Mar. 17, 2010
(86) PCT No.: PCT/EP2010/001664

§ 371 Date: Sep. 16, 2011

(30) Foreign Application Priority Data
Mar. 19, 2009 (DE) 10 2009 013 515.4

(51) Int. Cl. A47L 13/16; C08B 16/00

(52) U.S. Cl. 15/118; 536/57; 15/244.4

(57) ABSTRACT

A method for continuously producing sponge bodies (1) made of regenerated cellulose using at least partially agglomerated pore inducers made of sodium sulphate decahydrate is provided. First, a viscose solution is provided. A pore inducer is added to said viscose solution. The viscose solution is laid onto a conveyer belt which is continuously moving. The viscose solution is led through baths on the conveyor belt, resulting in a porous mass made of regenerated cellulose.

### CROSS-REFERENCED TO RELATED APPLICATIONS

This patent application is the national phase of PCT/EP2010/001664, filed Mar. 17, 2010, which claims the benefit of German Patent Application No. 102009013515.4, filed Mar. 19, 2009.

### FIELD OF THE INVENTION

The invention concerns a method for the production of sponge bodies from regenerated cellulose, using pore-forming agents made of sodium sulfate decahydrate. A viscose solution is first prepared. The pore-forming agent is admixed to this viscose solution. The viscose solution is placed on a conveying belt. The viscose solution is conducted on the conveying belt through baths, wherein a porous mass of regenerated cellulose forms and a sponge body can be obtained according to the method.

### BACKGROUND OF THE INVENTION

A method such as described above is disclosed in DE 196 23 704 C1. This reference indicates which method steps are generally required, so as to produce a sponge body from cellulose. In various method steps, viscose is produced from pulp in a xanthanating reaction. This is mixed with sodium sulfate decahydrate, also known as Glauber's salt, as a pore-forming agent, placed on a conveying belt, and conducted through several baths, wherein the xanthogenate is split up and the pore-forming agent is dissolved out. A sponge-like structure is thereby formed.

DE 1 569 226 discloses the agglomeration of the pore-forming agent to large crystals. The pore-forming agent is thereby compacted by pressing together to form large crystals. This method is particularly suitable for pore-forming agents made of sodium sulfate decahydrate, since it has a melting point of approximately 32° C. and melts thereby in its own water of crystallization. As a result of the pressing together, the crystals melt, in part. The individual crystals bind with one another and the bonding is retained after the pressing process has ended.

Sponge bodies can be produced either continuously or discontinuously. Continuous production is particularly effective, but with this method, the maximum thickness of the sponge body has been limited, up to now, to about 1 cm. Sponge bodies produced in such a manner can be further processed as rolled material which enables particularly effective further processing. To produce thicker sponge bodies, however, it is necessary to use a particularly slow conveyance speed and to apply a particularly large quantity of material. However, this raises the risk that the viscose-Glauber's salt mixture, placed on the conveying belt, will sink together and collapse the pores, producing a sponge body with a small thickness and a high bulk density. The discontinuous method permits the production of larger sponge bodies, but the production is more cumbersome and cost-intensive, and the sponge body must be cut to size on all sides, which leads to a large amount of waste material.

### SUMMARY OF THE INVENTION

An object of the invention is to develop a method for the production of a sponge body from regenerated cellulose that permits very thick sponge bodies to be produced at a relatively low cost.

To this end, a method is provided according to the invention for the continuous production of sponge bodies from regenerated cellulose using at least partially agglomerated pore-forming agents. First, a viscose solution is made. A pore-forming agent is added to this viscose solution. The viscose solution is placed on a conveyance belt, which moves continuously. The viscose solution on the conveyance belt is conducted through baths, wherein a porous mass of regenerated cellulose forms. The viscose solution, mixed with the pore-forming agent, is conducted through a liquid which is heated to approximately 100° C. The pore-forming agents melt thereby and due to the high salt concentration, the viscose solution coagulates on the interface, and stable pores are formed. Moreover, the viscose is converted into cellulose and the pore-forming agent is washed out from the sponge body which is now formed. Pore-forming agents, according to an aspect of the invention, can be made of an alkali or alkaline-earth metal salt of an inorganic acid. Sodium sulfate and magnesium sulfate can be used. Sodium sulfate decahydrate is particularly advantageous as a pore-forming agent. This pore-forming agent melts at 32° C., in its own water of crystallization. This allows the sponge body production process to run in a particular effective manner. The use of sodium sulfate decahydrate as the pore-forming agent for the previously described process is generally known.

In accordance with the invention, the production of the sponge body is carried out continuously by placing the viscose solution on a moving conveyance belt, so that the sponge bodies can be produced in a particularly effective and low-cost manner. Surprisingly, it was determined that the agglomerated pore-forming agents are mechanically stable during continuous production. Relatively large and also very uniform pores are thereby formed, so that sponge bodies with a great thickness and a particularly low bulk density can be produced. The large agglomerated pore-forming agents can be admixed, in large quantities, to the viscose solution. Thus, it is possible to admix 5 parts pore-forming agents to one part viscose solution. The result is a sponge body with a particularly low bulk density. Therefore, with a proper use of the sponge body, raw material and energy can be economized. This cost advantage is also manifested, in particular, in the production of thin sponge cloths with a thickness of approximately 0.5 cm. Moreover, it is not necessary to reduce the conveying speed of the conveyance belt in order to produce a sponge body of great thickness, in accordance with the invention. It is also conceivable to agglomerate only some of the pore-forming agents and to admix another part of the pore-forming agents, in the original particle size, to the viscose solution. One obtains thereby a mixture of pore-forming agents of different sizes, which leads to pores of different sizes. The finer pore-forming agents can thereby fill, in particular, gaps between the large pore-forming agents. Thus, as a result, a sponge body with a greater porosity can be produced than would be possible with the use of exclusively agglomerated pore-forming agents. Additives, in particular, cotton fibers and dyes, can be admixed to the viscose solution, so as to obtain better strength values and, especially, color developments of the sponge body.

The pore-forming agents can be pelleted. Pelleting is a purely mechanical process that compacts individual pore-forming agent crystals. In comparison to compacting processes in which the pore-forming agent is first melted so as to then crystallize it into large units, pelleting is a method which is particularly quick and requires relatively little energy. Depending on the design of the pelleting device, pore-forming agent pellets can be produced in different shapes and dimensions. Due to the pressure which the pelleting device exerts on the pore-forming agents, the pore-forming agent crystals melt on the particle interface and after the recrystallization, are bonded firmly with the adjacent pore-forming agent crystals. Thus, it is not necessary to add more heat energy. In the sense of the invention, pelleting is thus a special, namely purely mechanical method of compacting. Pelleting does not include compacting methods in which the compacting comprises a melting and a subsequent crystallizing of the pore-forming agent to form large units.

The pore-forming agents can be present in the form of little rods. Such forms can be produced in a particularly simple manner. For example, the pore-forming agents can also be pressed by a screen element. The thickness and the length of the compacted pore-forming agents can be adapted.

The pore-forming agent can be present in the shape of rice grains. For the stability of the sponge body, it is advantageous if the pore-forming agents and thus the pores formed from the pore-forming agents have a rounded-off shape with no sharp edges. In this sense, it is also conceivable that the pore-forming agents can be produced in other rounded-off configurations.

A sponge body produced in accordance with the method of the invention can have a thickness of up to 3 cm, preferably, up to 2 cm. A sponge body, which is produced with small crystalline pore-forming agents, according to the usual known method, has a maximum thickness of approximately 1 cm. In order to attain this thickness with the known method, however, it is necessary to very greatly reduce the conveying speed. The method permits the continuous production of sponge bodies which are substantially thicker than 1 cm, namely up to 3 cm, with the sponge body, in accordance with the invention, having a particularly low bulk density.

The bulk density of the sponge body can be between 35 and 55 kg/m³. The density of the porous sponge body, including the pores enclosed in the sponge body, is designated as the bulk density. The bulk density is also designated as the gross density. Usually, the bulk density of a sponge body which was produced in a continuous method is approximately 60 kg/m³ with a density which is typically in the range smaller than 1 cm. Therefore, for the sponge body, in accordance with the invention, a smaller quantity of viscose solution per unit volume is required. Such sponge bodies with a low bulk density advantageously have a particularly high water absorption capacity.

The sponge body can have at least two main sides. Such sponge bodies are designed essentially flat as is, for example, known of sponge cloths. Both main sides can thereby form wipe surfaces and can be brought into contact with the surface to be cleaned.

At least one main side can be formed with a skin. Such a skin is always formed on the interface of the sponge body in the raw state in a production according to the previously described method. Discontinuously produced sponge bodies frequently do not have such a skin, since the sponge body must be cut to size on all sides. With these sponge bodies, the cut surface forms the interface. With the sponge body according to the invention, it is particularly advantageous that it can be produced with a great thickness and with the main sides having the desired profile from the very beginning. It is only necessary for the sponge body to be cut to the desired size on its sides. With a sponge body with skin, it is particularly advantageous that due to the relatively closed surface, the sponge body can be particularly stable, mechanically, have a pleasant feel, but nevertheless absorb water well.

At least one main side can be profiled. With the sponge body according to the invention, the imprinting of the profiling takes place already with the placing of the viscose solution on the conveyance belt.

At least one main side can be provided with an abrasive layer. The abrasive layer can be sprayed or laminated on. The spraying of the abrasive layer can be integrated into the production process in a particularly simple and effective manner. The abrasive layer can thereby consist of a binder, for example, a resin, and abrasive particles of an organic and/or inorganic origin.

Some embodiment examples of the method in accordance with the invention and the sponge body in accordance with the invention are described, below, in more detail with the aid of the figures.

### BRIEF DESCRIPTION OF THE SEVERAL VIEWS OF THE DRAWINGS

FIG. 1 is a schematic, cross-sectional view of an exemplary sponge cloth according to the invention.

FIG. 2 is a schematic, cross-sectional view of an exemplary sponge cloth with an abrasive coating according to the invention.

### DETAILED DESCRIPTION OF THE INVENTION

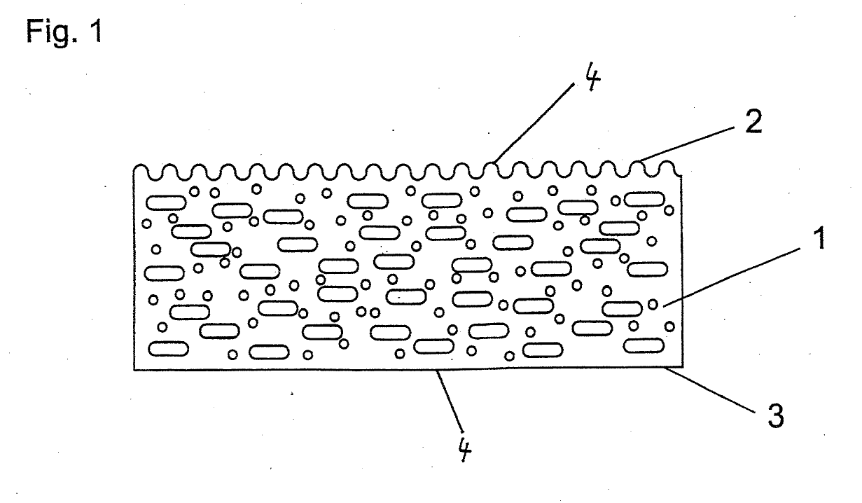

FIG. 1 shows a sponge body 1 that is produced from regenerated cellulose. The production of the sponge body 1 takes place in a continuous method, using partially agglomerated pore-forming agents made of sodium sulfate decahydrate. To this end, the pore-forming agents were pelleted in a pelleting device. In this case, the rollers of the pelleting device are designed in such a manner that the pore-forming agents are present in the shape of rice grains. For the production of the sponge body 1, a viscose solution is first produced according to the known xanthogenating method. The pore-forming agent is admixed to this viscose solution. The viscose solution with the admixed pore-forming agent is placed, by means of an extruder, on a continuously moving conveyance belt. Subsequently, the viscose solution on the conveyance belt is conducted through baths containing hot water and perhaps sodium hydroxide. The pore-forming agents thereby melt. The viscose solution begins to coagulate around the liquified pore-forming agents and a porous mass of regenerated cellulose is formed.

The illustrated sponge body 1, produced according to this method, has a thickness of 2.5 cm and a bulk density of 50 kg/m³. The sponge body 1 is a flat object with two main sides 2,3. Both sides can be used as wiping surfaces. Both sides 2, 3 are delimited by the formed skin 4 from the production process. A main side 2 is profiled and has a grooved structure.

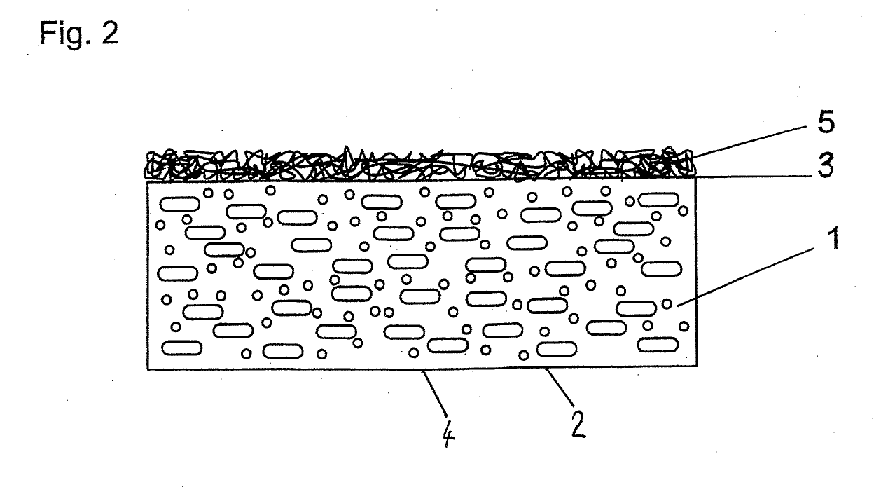

FIG. 2 shows a sponge structure similar to that of FIG. 1, however the sponge body 1 of FIG. 2 is provided with an abrasive layer 5 on a main side 3. The abrasive layer 5 consists of a binder and inorganic abrasive particles. The abrasive layer 5 was applied on the sponge body via a spraying process. In other embodiments, the abrasive layer can consist of bound fibers.

1-10. (canceled)

11. A method for the continuous production of sponge bodies from regenerated cellulose using, at least in part, agglomerated pore-forming agents comprising the steps of:
providing a viscose solution;
admixing a pore-forming agent to the viscose solution;
placing the viscose solution on a continuously moving conveyance belt;
conducting the viscose solution on the conveyance belt through baths, wherein a porous mass is formed from regenerated cellulose.

12. The method according to claim 11, wherein the pore-forming agent is pelleted.

13. The method according to claim 11, wherein the pore-forming agent is present in the form of small rods.

14. The method according to claim 11, wherein the pore-forming agent is present in the form of rice grains.

15. A sponge body, produced according to the method according to claim 11, wherein the sponge body has a thickness up to 3 cm.

16. The sponge body according to claim 15, wherein the bulk density of the sponge body is between 35 and 55 kg/m³.

17. The sponge body according to claim 15, wherein the sponge body has at least two main sides.

18. The sponge body according to claim 17, wherein at least one main side is formed by a skin.

19. The sponge body according to claim 15, wherein at least one main side is profiled.

20. The sponge body according to claim 15, wherein at least one main side is provided with an abrasive layer.
